(19) United States
(12) Patent Application Publication
(10) Pub. No.: US 2026/0318518 A1
(43) Pub. Date: Oct. 15, 2026

(54) LED LAMP

(71) Applicant: SHENZHEN SNC OPTO ELECTRONIC CO., LTD, Shenzhen (CN)

(72) Inventors: Jianyong XU, Shenzhen (CN); Shaohua FU, Shenzhen (CN)

(73) Assignee: SHENZHEN SNC OPTO ELECTRONIC CO., LTD, Shenzhen (CN)

(21) Appl. No.: 19/452,475

(22) Filed: Jan. 19, 2026

(30) Foreign Application Priority Data
Apr. 9, 2025 (CN) 202510436333.7

(51) Int. Cl. F21V 23/00; F21V 5/00; F21V 23/04; F21Y 105/16; F21Y 113/13; F21Y 115/10

(52) U.S. Cl. CPC F21V 23/003; F21V 5/007; F21V 23/04; F21Y 2105/16; F21Y 2113/13; F21Y 2115/10

(57) ABSTRACT

The present disclosure provides an LED lamp, which relates to the technical field of lighting technologies. The LED lamp includes a base with an installation groove, an LED plate received in the installation groove, a lens covered outside the LED plate, a power supply electrically connected to the LED plate, and a control device electrically connected to the power supply and configured to control the LED plate to emit light. The LED plate includes a substrate and a plurality of groups of LED beads installed at different positions of the substrate. The control device is configured to control at least one group of the plurality of groups of LED beads to emit light, to adjust light emission distribution of the LED lamp. The present disclosure can flexibly adjust the light emission distribution of the LED lamp.

### 1. CROSS-REFERENCE TO RELATED APPLICATION

This application claims the benefit of priority from Chinese Patent Application No. 202510436333.7 entitled “LED LAMP” and filed on Apr. 09, 2025, the content of which is hereby incorporated by reference in its entire by references.

### BACKGROUND

### 2. Technical Field

The present disclosure generally relates to the field of lighting technologies, and especially relates to an LED lamp.

### 3. Description of Related Art

With the increasing awareness of energy crisis and environmental protection, LED lamps have been widely used in many fields such as indoor lighting, outdoor advertising and traffic signals, due to significant advantages such as energy conservation and environmental protection, a long service life and a fast response speed. Compared to conventional incandescent lamps and fluorescent lamps, the LED lamps not only can significantly reduce energy consumption and carbon emissions, but also effectively lower maintenance costs, so that the LED lamps are highly favored by the market.

However, the conventional LED lamps still have certain limitations in practical applications. At present, in order to optimize the light propagation effect of the LED lamps, most LED lamps are equipped with lens plates to achieve light convergence, light diffusion, or light angle adjustment thereof. However, a position that the lens plate of the conventional LED lamp is usually fixed, so that this structural design makes the LED lamp difficult to flexibly adjust the position of the lens plate according to actual needs when the LED lamp is applied for different usage scenarios, thereby making it difficult to effectively control a direction of light distribution of the LED lamp.

### SUMMARY

The technical problems to be solved: in view of the shortcomings of the related art, the present disclosure provides an LED lamp which can facilitate to effectively control of light emission distribution of the LED lamp.

In order to solve the above objectives, an LED lamp according to an embodiment of the present disclosure includes:
a seat with an installation groove thereof;
an LED plate received in the installation groove;
a lens covered outside the LED plate;
a power supply electrically connected to the LED plate; a
control device electrically connected to the power supply and configured to control the LED plate to emit light; and wherein

the LED plate includes a substrate and a plurality of groups of LED beads arranged in different areas of the substrate in a mutually spaced manner; and wherein color temperatures and light emission angles of at least two groups of the plurality of groups of LED beads are different, and the control device is configured to independently control at least one group of the plurality of groups of LED beads to emit light.

Wherein the substrate is square, and the plurality of groups of LED beads is arranged in an array along directions parallel to long sides and short sides of the substrate, respectively.

Wherein the plurality of groups of LED beads includes a first bead, a second bead, a third bead and a fourth bead, wherein the first bead and the second bead are distributed in an array at a middle position of the substrate, and the third bead and the fourth bead are respectively surrounded around the periphery of the first bead and the second bead.

Wherein the first bead and the second bead form a plurality of rows that is arranged in sequence along a width direction of the substrate, each row of first beads or the second beads are evenly distributed along a length direction of the substrate, wherein the first beads is arranged on odd rows, while the second beads are arranged on even rows, and the second beads in each even row are offset relative to the first beads in adjacent odd rows along the length direction of the substrate.

Wherein the first beads and the second beads also form a plurality of columns, wherein odd columns are composed of the first beads and even columns are composed of the second beads; and wherein a plurality of isosceles right-angled triangles is formed between the first beads and the second beads, two right-angled sides of each of the plurality of isosceles right-angled triangles extending along the length and width directions of the substrate, respectively, a vertex of the right-angled triangle is either the first bead or the second bead, two ends of the hypotenuse are either two first beads or two second beads, and the two first beads and the two second beads in the hypotenuse are alternately arranged.

Wherein the plurality of rows of third and fourth beads is arranged in a plurality of concentric rectangular rings along the peripheral area of the substrate, wherein at least one rectangular ring of the plurality of concentric rectangular rings is composed of the third beads, at least another rectangular ring is composed of the fourth beads, and the plurality of rectangular rings are alternately arranged by the third beads and the fourth beads, and adjacent rectangular rings are nested with each other; and wherein a distance between two adjacent third beads is equal to a distance between two adjacent fourth beads, and in two adjacent rectangular rings, the third beads and the fourth beads are arranged opposite each other in a direction perpendicular to an edge of the ring.

Wherein a color temperature of the first bead is 5000K and emission angles are 5H5V and 6H6V, a color temperature of the second bead is 3000K and emission angles are 5H5V and 6H6V, a color temperature of the third bead is 5000K and an emission angle is 7H7V, and a color temperature of the fourth LED bead is 3000K and an emission angle is 7H7V.

Wherein the control device includes an angle controller including a first base installed on the seat, a first switch arranged on the first base, and a first lever, wherein the first switch is electrically connected to the power supply and the plurality of groups of LED beads, respectively, and has a plurality of states, and the first switch is configured to control at least one group of the plurality of groups of LED beads to emit light by adjusting different states of the plurality of states.

Wherein the plurality of states of the first switch includes seven states:
when the switch is in a first state, the first beads turn on to emit light; and wherein
when the switch is in a second state, the first and second beads turn on to emit light; and wherein
when the switch is in a third state, the second beads turn on to emit light; and wherein
when the switch is in a fourth state, the plurality of groups of LED beads is simultaneously turned on to emit light; and wherein
when the switch is in a fifth state, the third beads turn on to emit light; and wherein
when the switch is in a sixth state, the third and fourth beads turn on to emit light; and wherein
when the switch is in a seventh state, the fourth beads turn on to emit light.

Wherein the lens includes a central lens module and a peripheral lens module connected with each other, wherein the peripheral lens module is corresponding to the third beads and the fourth beads, and the central lens module is corresponding to the first beads and the second beads.

Wherein the central lens module includes a plurality of central lens units arranged in one-to-one correspondence with the first beads and the second beads.

Wherein each of the plurality of central lens units includes a hemispherical convex portion and a convex ring portion wound around the outside of the hemispherical convex portion, wherein the hemispherical convex portion protrudes from the convex ring portion.

Wherein the peripheral lens module includes a plurality of rectangular convex lens units arranged in sequence, each of the plurality of rectangular convex lens units corresponding to a rectangular ring that is formed by enclosing the third bead and the fourth bead.

Wherein the control device further includes a power controller including a second base, a second switch, and a second lever, wherein the second switch is electrically connected to the power supply and the LED plate, respectively, and has a plurality of states, the second lever connected to the second switch and configured to be turned to change the state of the second switch, and the second switch configured to control an output power of the LED lamp according to different states thereof.

Wherein the control device further includes a color temperature controller including a third switch and a third lever, wherein the third switch is fixedly installed on the second base and electrically connected to the power supply and the LED plate, respectively, and has a plurality of states; and wherein the third lever is connected to the third switch and configured to be turned to change the state of the third switch, and the third switch is configured to control the color temperature of the LED lamp according to different states thereof.

Wherein the control device further includes a main switch configured to control the LED lamp to be turned on or turned off.

Wherein the LED lamp further includes a transparent cover installed on the seat and located on the outer of the lens.

An LED lamp according to another embodiment of the present disclosure includes:
a seat with an installation groove thereof;
an LED plate received in the installation groove;
a lens covered outside the LED plate;
a power supply electrically connected to the LED plate;
a control device electrically connected to the power supply and configured to control the LED plate to emit light; and wherein

the LED plate includes a substrate and first beads, second beads, third beads and fourth beads attached to the substrate, respectively, wherein the first beads and the second beads are located at a middle position of the substrate, and the third beads and the fourth beads are surrounded around the periphery of the first beads and the second beads; and wherein the control device is configured to control at least one of the first beads, the second beads, the third beads and the fourth beads to emit light, so as to adjust light emission distribution of the LED lamp.

Wherein the first beads, the second beads, the third beads and the fourth beads are respectively yellow beads, pink beads, blue beads and green beads, wherein the first beads and the second beads form a plurality of rows that is arranged in sequence along a width direction of the substrate, each row of first beads or the second beads are evenly distributed along a length direction of the substrate, wherein the first beads is arranged on odd rows, while the second beads are arranged on even rows, and the first beads and the second beads in adjacent rows are staggered along the length direction of the substrate; and wherein the third beads and the fourth beads are arranged in a plurality of concentric rectangular rings along the peripheral area of the substrate, wherein at least one rectangular ring of the plurality of concentric rectangular rings is composed of the third beads, at least another rectangular ring is composed of the fourth beads, and the plurality of rectangular rings are alternately arranged by the third beads and the fourth beads, and adjacent rectangular rings are nested with each other; and wherein a distance between two adjacent third beads is equal to a distance between two adjacent fourth beads, and in two adjacent rectangular rings, the third beads and the fourth beads are arranged opposite each other in a direction perpendicular to an edge of the ring.

Wherein a bottom wall of the installation groove protrudes towards a side of the LED plate to form a bulge, and the LED plate is installed on the bulge, wherein the LED lamp further includes an installation bracket installed on the seat, wherein the installation bracket includes a first bracket and a second bracket connected to each other, the second bracket configured to connect the LED lamp to the outside, and the first bracket and the second bracket rotatably connected to each other.

The LED lamp of the present disclosure is provided that the control device is configured to flexibly adjust the light distribution of the LED lamp by controlling at least one group of the plurality of groups of LED beads that are installed at different positions of the substrate to emit light.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a schematic view of an LED lamp in accordance with an embodiment of the present disclosure.

FIG. 2 is similar to FIG. 1, but shown from another view.

FIG. 3 is an exploded, schematic view of the LED lamp of FIG. 1.

FIG. 4 is a schematic view of an LED plate of the LED lamp of FIG. 1.

FIG. 5 is a partial schematic view of the LED lamp of FIG. 1.

FIG. 6 is a schematic view of a lens of the LED lamp of FIG. 1.

FIG. 7 is a schematic view of light emission after simulating an emission angle of a central lens module of the LED lamp of FIG. 1 through an optical software.

FIG. 8 is a schematic view of light emission after simulating an emission angle of a peripheral lens module of the LED lamp of FIG. 1 through the optical software.

FIG. 9 is a schematic view of a seat of the LED lamp of FIG. 1.

FIG. 10 is similar to FIG. 9, but shown from another view.

The element labels according to the embodiment of the present disclosure shown as below:

100 LED lamp, 10 seat, 11 installation groove, 111 bottom wall, 112 bulge, 113 heat dissipation fin, 20 LED plate, 21 substrate, 22 LED bead, 221 first bead, 222 second bead, 223 third bead, 224 fourth bead, 30 lens, 31 central lens module, 311 central lens unit, 3111 hemispherical convex portion, 3112 convex ring portion, 32 peripheral lens module, 321 rectangular convex lens unit, 40 power supply, 50 control device, 51 angle controller, 511 first base, 512 first switch, 513 first lever, 52 power controller, 521 second base, 522 second switch, 523 second lever, 53 color temperature controller, 531 third switch, 532 third lever, 54 main switch, 541 fourth switch, 542 fourth lever, 60 transparent cover, 70 installation bracket, 71 first bracket, 72 second bracket.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described exemplary embodiment of the present disclosure, all other embodiments obtained by one of ordinary skill in the related art on the premise of no creative work are within the protection scope of the present disclosure.

It should also be noted that if terms such as directional indications of “up”, “down”, “left”, “right”, “front” and “back”, etc. are involved in the embodiments of the present disclosure, the directional indications are only used to explain a relative position relationship and a motion condition etc between components in a specific posture. If the specific posture changes, the directional indications will also change accordingly.

In addition, the terms such as “first” and “second” shown in the specification are only used to describe, but not indicated that the elements of the present disclosure are important or represented the amount of the elements. That is, the features limited by the terms of “first” and “second” may explicitly or implicitly include one or more features. Furthermore, it should also be further understood that the term “and/or” used in the description of the present disclosure refers to include three parallel schemes that it is taken “A and/or B” as an example, which includes an A scheme, or a B scheme, or both A and B schemes. In addition, technical solutions among various embodiments can be combined with each other, but it should be implemented for one of ordinary skill in the related art. When the combination of technical solutions is contradictory or impossible to be implemented, it should be considered that such combination of technical solutions does not exist and is not within the protection scope of the present disclosure.

The structural design of the LED lamp in the market is provided to make it difficult to effectively control the light distribution direction of the LED lamp according to actual needs when the LED lamp is applied for different usage scenarios. Therefore, the present disclosure provides an LED lamp that can adjust the light distribution of the LED lamp without adjusting the position of the lens plate.

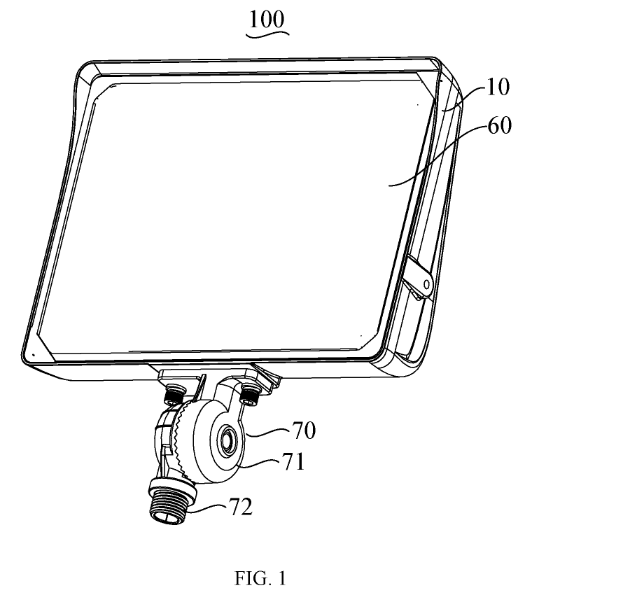

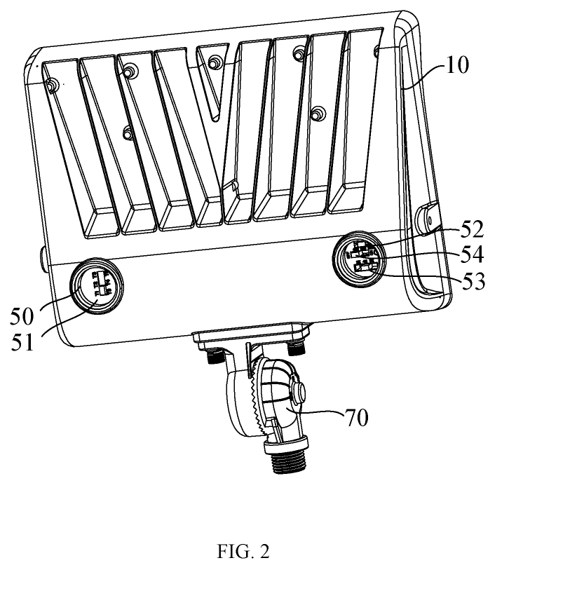

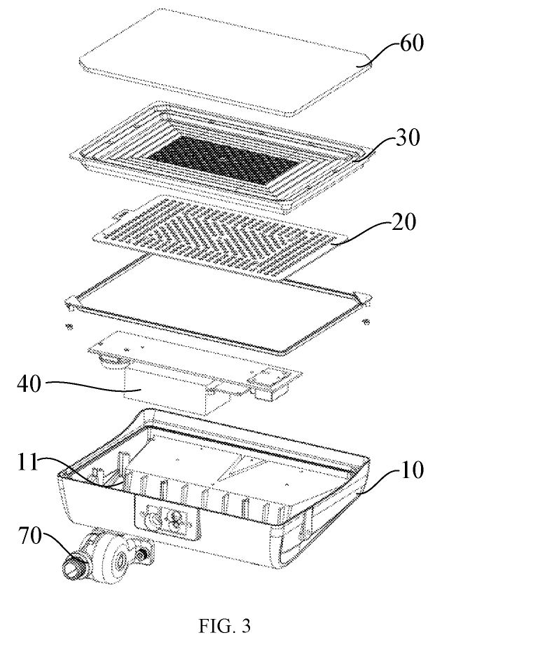

Referring to FIGS. 1-4, an LED lamp 100 according to an embodiment of the present disclosure includes a seat 10, an LED plate 20, a lens 30, a power supply 40 and a control device 50. A surface of the seat 10 is recessed inwardly to form an installation groove 11, the LED plate 20 is received in the installation groove 11, and a light emission direction of LED beads 22 faces the outside of the installation groove 11. The lens 30 is placed outside the LED beads 22 to adjust the light emitted from the LED plate 20. The power supply 40 is installed inside the seat 10 and electrically connected to the LED plate 20. The control device 50 is installed on the seat 10 and electrically connected to the power supply 40 to control the LED plate 20 to emit light. The LED beads 22 include a substrate 21, and a plurality of groups of LED beads 22 arranged in different areas of the substrate 21 in a spaced manner. A color temperature and a light emission angle of at least two groups of the plurality of groups of LED beads 22 are different. The control device 50 is configured to independently control at least one group of the plurality of groups of LED beads 22 to emit light, so as to adjust the light distribution of the LED lamp 100 to meet different needs.

Specifically, the seat 10 serves as a foundational support structure of the LED lamp 100. On the light-emitting side, a surface is recessed inward to form the installation groove 11 for providing a mounting space for other components and fulfilling functions of securing and protecting internal parts thereof. The LED plate 20 is installed within the installation groove 11 of the seat 10, and includes the substrate 21 and the plurality of groups of LED beads 22 that is mounted at various positions of the substrate 21. The LED beads 22 is the core component responsible for light emission, with the light emission direction facing the exterior of the installation groove 11 (that is, directed towards the lens 30 to allow the light to pass through the lens 30), which can convert electrical energy into light energy, for providing the light source for the LED lamp 100. The lens 30 that covers the LED beads 22 is a key component for regulating light propagation thereof, which can perform functions such as focusing the light, diffusing the light, or adjusting the angle of the light emitted from the LED plate 20, thereby optimizing the light propagation effect thereof. The power supply 40 is installed inside the seat 10, for serving to provide a stable power to the LED plate 20 and ensuring a normal illumination of the LED beads 22. The control device 50 is also mounted within the seat 10 for functioning as a central control unit of the entire LED lamp 100 to regulate a operational status of the LED lamp 100.

In terms of mechanical connection, the LED lamp 100 of the present disclosure provides that the LED plate 20 is fixedly installed in the installation groove 11 of the seat 10, and the lens 30 is covered outside the LED beads 22, thereby tightly cooperating with the LED plate 20. The control device 50 and the power supply 40 are both installed inside the seat 10, and each component forms a complete lamp structure under the support of the seat 10. In terms of electrical connection, the power supply 40 is electrically connected to the LED plate 20 through wires, thereby supplying power to the LED plate 20. The control device 50 is electrically connected to the power supply 40 to control the power output from the power supply 40 to the LED plate 20, thereby controlling a light emission state of the LED plate 20.

In an embodiment of the present disclosure, by controlling the at least one group of the plurality of groups of LED beads 22 to emit light through the control device 50, the color temperature and the light emission angle of at least two groups of the plurality of groups of LED beads 22 can be different. Combined with that the lens 30 is provided to adjust the light, flexible adjustment of the light emission distribution of the LED lamp 100 can be achieved. In scenes that require to be centralized lighting, such as display cabinets at museums, the control device 50 can select the LED beads 22 that are arranged at specific positions to emit light, and converge the light through the lens 30 to concentrate the light on the exhibits. While, in conference room scenes that require large areas of uniform lighting, the control device 50 can make the plurality of groups of LED beads 22 work together to emit light, and then use the lens 30 to diffuse the light, thereby meeting the diverse lighting needs of different scenes and effectively improving the applicability and effectiveness of the LED lamp 100.

It should be noted that the seat 10 can be made of metal material, which not only provides an installation space for other components, but also has good thermal conductivity, so that it can quickly dissipate the heat generated by components such as the LED beads 22 during being operated, thereby effectively avoiding the deterioration of lamp performance or a shortened service life due to heat accumulation, and significantly improving the heat dissipation efficiency and stability of the LED lamp 100.

Furthermore, the substrate 21 is square, and the plurality of groups of LED beads 22 is arranged in an array along directions parallel to long sides and short sides of the substrate 21, respectively. the plurality of groups of LED beads 22 includes a first bead 221, a second bead 222, a third bead 223 and a fourth bead 224, wherein the first bead 221 and the second bead 222 are distributed in an array at a middle position of the substrate 21, and the third bead 223 and the fourth bead 224 are respectively surrounded around the periphery of the first bead 221 and the second bead 222.

Specifically, in an embodiment of the present disclosure, the substrate 21 serves as the support structure for the LED beads 22, and adopts a square design to provide a mounting plane for the LED beads 22. The substrate 21 can be made of aluminum-based copper-clad laminates, which have excellent electrical insulation and thermal conductivity properties, with a thermal conductivity of up to 2.0W/(m · K), thereby effectively dissipating the heat generated by the LED beads 22. A surface of the substrate 21 is treated with an immersion gold technology to enhance the antioxidant capacity and ensure the stability of circuit connections. A plurality of independent circuit traces are etched on the substrate 21 to provide independent power and control circuits for different groups of LED beads 22. The first bead 221 and the second bead 222 are set at a middle of the substrate 21. The third bead 223 and the fourth bead 224 are surrounded around the periphery of the first bead 221 and the second bead 222.

Furthermore, the first bead 221 and the second bead 222 form a plurality of rows that is arranged in sequence along a width direction of the substrate 21, each row of first beads 221 or second beads 222 are evenly distributed along a length direction of the substrate 21, wherein the first beads 221 is arranged on odd rows, while the second beads 222 are arranged on even rows, and the second beads 222 in each even row are offset relative to the first beads 221 in adjacent odd rows along the length direction of the substrate 21.

Specifically, in an embodiment of the present disclosure, the first bead 221 and the second bead 222 form a multi-row arrangement structure. The plurality of rows refers to a stacking arrangement along the width direction of the substrate 21, with the first beads 221 or the second beads 222 in each row being evenly distributed along the length direction of the substrate 21, and a constant space maintained between adjacent first beads 221 and second beads 222. In this arrangement, all odd rows are composed of the first beads 221, and all even rows are composed of the second beads 222, thereby achieving a type alternation between the first beads 221 and the second beads 222 in the row direction. The first beads 221 and the second beads 222 in adjacent rows are staggered in the length direction of the substrate 21, with a distance of half the distance between adjacent first beads 221 or second beads 222 of the same type. Thus, each second bead 222 is approximately located directly above (or below) a gap between adjacent first beads 221 in the length direction of the substrate 21, for forming a staggered nested matrix layout thereof.

The above structural design enables the first bead 221 and the second bead 222 to be spatially controllable and optically coupled tightly. When the control device 50 independently drives odd rows of first beads 221 or even rows of second beads 222, it can activate light sources of different areas to dynamically adjust the light emission angle, a light intensity distribution, or a color temperature gradient. Due to the staggered arrangement of adjacent rows of beads 221, 222 in the length direction of the substrate 21, it effectively avoids bright and dark stripes or hotspot concentration during light superposition being occurred, thereby significantly improving the overall uniformity and visual comfort that the light is emitted from the LED lamp 100. In addition, the uniform space between the first and second beads 221, 222 and the mis-arrangement of alignment also provide a regular light distribution basis for designing the lens 30, which is conducive to simplifying a secondary optical system and improving the efficiency of light utilization.

Furthermore, the first beads 221 and the second beads 222 also form a plurality of columns, wherein odd columns are composed of the first beads 221 and even columns are composed of the second beads 222; and wherein a plurality of isosceles right-angled triangles is formed between the first beads 221 and the second beads 222, two right-angled sides of each of the plurality of isosceles right-angled triangles extending along the length and width directions of the substrate 21, respectively, a vertex of the right-angled triangle is either the first bead 221 or the second bead 222, two ends of the hypotenuse are either two first beads 221 or two second beads 222, and the two first beads 221 and the two second beads 222 in the hypotenuse are alternately arranged.

Specifically, in an embodiment of the present disclosure, the first beads 221 and the second beads 222 of the LED plate 20 not only arranged in rows, but also further form a multi-column structure, wherein all odd columns are composed of the first beads 221, and all even columns are composed of the second beads 222, thus constructing a regular checkerboard array on the substrate 21. On this basis, any one of the first beads 221 and the second bead 222 adjacent to the first bead 221 in the length direction of the substrate 21, and the second bead 222 adjacent to the first bead 221 in the width direction of the substrate 21 jointly enclose to form an isosceles right-angled triangular unit. Correspondingly, any second bead 222 can also form a similar isosceles right-angled triangle with adjacent first beads 221 in the length and width directions of the substrate 21. The two right-angled sides of each isosceles right-angled triangle extend strictly along the length and width directions of the substrate 21, and the vertex of the isosceles right-angled triangle is either the first bead 221 or the second bead 222. The sequence of beads extending along an oblique direction of each isosceles right-angled triangle (that is, the diagonal direction at an angle of 45 ° to a long side of the substrate 21) is alternately arranged by the first bead 221 and the second bead 222. Due to the fact that the sequence contains an odd number of beads (such as three, five etc.), the types of beads at the beginning and end of the sequence are the same, that is, both ends of the oblique direction sequence are either the first beads 221 or the second beads 222. This arrangement allows the same type of beads to be separated by different types of beads in the diagonal direction, for forming a periodic alternating optical distribution thereof.

The above structural design brings multiple collaborative technical effects: dual alternation of rows and columns (odd even rows+odd even columns) combined with diagonal alternation, resulting in a highly uniform intensity gradient of the light source in the three main directions of the horizontal direction, the vertical direction and the diagonal direction, effectively suppressing the common grid effect and light dark stripes in conventional matrix arrays. A regular geometric configuration of the isosceles right-angled triangle elements provides a natural symmetrical element for a microstructure design of secondary optical lenses, resulting in facilitating precise light distribution and efficient utilization of light energy. The odd alternating sequence in the oblique direction ensures the continuity of light superposition in edge areas, thereby avoiding local over brightness or color cast caused by the aggregation of the same type of beads.

Furthermore, the plurality of rows of third and fourth beads 223, 224 is arranged in a plurality of concentric rectangular rings along the peripheral area of the substrate 21, wherein at least one rectangular ring of the plurality of concentric rectangular rings is composed of the third beads 223, at least another rectangular ring is composed of the fourth beads 224, and the plurality of rectangular rings are alternately arranged by the third beads 223 and the fourth beads 224, and adjacent rectangular rings are nested with each other; and wherein a distance between two adjacent third beads 223 is equal to a distance between two adjacent fourth beads 224, and in two adjacent rectangular rings, the third beads 223 and the fourth beads 224 are arranged opposite each other in a direction perpendicular to an edge of the ring.

Specifically, in an embodiment of the present disclosure, the third beads 223 and the fourth beads 224 are arranged on the peripheral area of the LED plate 20, which together form a multi-layer optical boundary structure. The third beads 223 and the fourth beads 224 are arranged in the plurality of concentric rectangular rings along the peripheral area of the substrate 21, with sharing the same center thereof. The plurality of rectangular rings is arranged in sequence from the inside to the outside of the center, and adjacent rectangular rings are nested with each other, for forming a regular hierarchical enclosing layout. In this layout, at least one rectangular ring is entirely composed of the third beads 223, and at least another rectangular ring is entirely composed of the fourth beads 224. The plurality of rectangular rings is arranged from the inside to the outside of the center in an alternating manner with the third and fourth beads 223, 224, that is, the inner layer is the third beads 223, an adjacent outer layer is the fourth beads 224, and a next outer layer is again the third beads 223, and so on, to achieve an orderly distribution of different types of beads at the ring level thereof. The distance between two adjacent third beads 223 is equal to the distance between two adjacent fourth beads 224, so that all peripheral beads 223, 224 maintain a uniform pitch in the circumferential direction (that is, along the edge of the rectangular ring). In any two adjacent rectangular rings, the fourth beads 224 of the outer ring and the third beads 223 of the inner ring are arranged opposite to each other along a direction perpendicular to the edge of the ring, so that the beads of the outer ring is roughly located on the outer side of the beads at the corresponding position of the inner ring.

The newly added arrangement of the beads has positively impacted a circuit layout of the substrate 21, a design of the lens 30, and the overall mechanical structure. The circuit routing on the substrate 21 can be designed with layered and zoned layouts based on the row-column and circular distribution of the beads, thereby optimizing the circuit configuration, reducing electromagnetic interference, and enhancing the stability and reliability of electrical connections thereof. The lens 30 can be specifically designed with a plurality of optical units featuring different curvatures and angles based on the arrangement of the beads. These units precisely converge, diffuse and refract the light emitted by the central matrix beads and the peripheral ring beads, for further enhancing optical adaptability thereof. In terms of the mechanical structure, the ring-shaped arrangement of beads ensures more uniform weight distribution across the LED plate 20, enhances the secure fit with the seat 10, and improves the overall structural strength and stability of the LED lamp 100. The standardized arrangement of rows and columns, and circular beads facilitates to use an automated mounting equipment for performing high-speed and precise bead welding operations during the production process, thereby greatly improving production efficiency and reducing production costs. At the same time, this standardized arrangement also enables to quickly position faulty beads during performing lamp maintenance thereof, so that it is more convenient and efficient to replace individual bead or repair local circuits. Based on the row-column and circular composite arrangement of the beads, the lens 30 can adopt a modular and layered innovative design. Each optical unit corresponds to a specific area of beads, and through performing parameter optimization and combination on different optical units, diversified control of the light can be achieved. For example, a diffusion-type optical unit can be designed for the circular beads, and a convergence-type optical unit can be designed for the row and column beads to meet personalized needs of light angles, intensities and distribution forms in different scenarios, thereby significantly improving the optical performance and application flexibility of the LED lamp 100.

Furthermore, a color temperature of the first bead is 5000K and emission angles are 5H5V and 6H6V, a color temperature of the second bead is 3000K and emission angles are 5H5V and 6H6V, a color temperature of the third bead is 5000K and an emission angle is 7H7V, and a color temperature of the fourth LED bead is 3000K and an emission angle is 7H7V, wherein H represents a height and V represents a width.

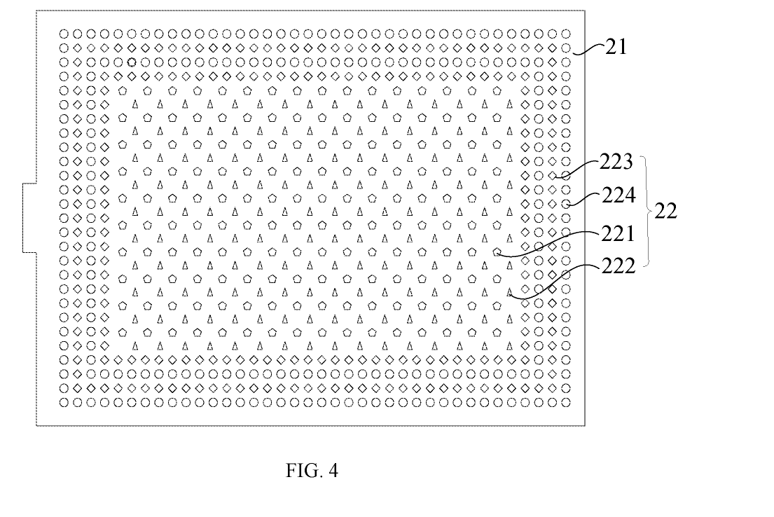

Specifically, the four types of beads emit white light. As shown in FIG. 4, the second bead 222 that is a pink bead includes two groups of beads. Corresponding optical surfaces of one group of beads emit light at an emission angle of 5H5V (70-100 degrees), and the other group of corresponding optical surfaces emit light at an emission angle of 6H6V (100-130 degrees). In the embodiment of the present disclosure, the two types of beads can be alternately arranged at the middle of the substrate 21.

The first bead 221 that is highlighted a yellow bead also includes two groups of beads, corresponding optical surfaces of one group of beads emitting light at an angle of 5H5V (70-100 degrees), and the other group of corresponding optical surface emitting light at 6H6V (100-130 degrees). In the embodiment of the present disclosure, the two types of beads can be alternately arranged at the middle of the substrate 21.

The emission angle emitted by the optical surface corresponding to the fourth bead 224 that is a green bead is 7H7V (greater than 130 degrees), and the emission angle emitted by the optical surface corresponding to the third bead 223 that is a cyan bead is 7H7V (greater than 130 degrees). The green fourth bead 224 and the cyan first bead 223 can be alternately arranged on the periphery of the substrate 21.

This combination of beads with multi-color temperatures and multi-emission angles allows the LED lamp 100 to achieve rich color mixing effects by controlling the emission of different groups of beads, FOR meeting diverse lighting needs.

The present disclosure can adjust a required color temperature by combining different beads.

When a color temperature of 3000K is required, pink beads and green beads are turned on to emit light. The two groups of beads corresponding to the pink beads. One group of corresponding optical surfaces emits light at an emission angle of 5H5V (70-100 degrees) with a brightness of 80%, while the other group of corresponding optical surfaces emits light at 6H6V (100-130 degrees) with a brightness of 20%. There is only one optical surface marked in green, which is 7H7V and has a brightness of 10%.

When a color temperature of 5000K is required, yellow beads and cyan beads are turned on to emit light. The two groups of beads corresponding to the yellow beads. One group of corresponding optical surfaces emits light at an emission angle of 5H5V (70-100 degrees) with a brightness of 20%, while the other group of corresponding optical surfaces emits light at 6H6V (100-130 degrees) with a brightness of 80%. There is only one optical surface marked in cyan, which is 7H7V and has a brightness of 10%.

When a color temperature of 4000K is required (3000K+5000K are mixed to be equal 4000K), the brightness of the beads under an emission angle of 5H5V, 6H6V and 7H7V is 100%.

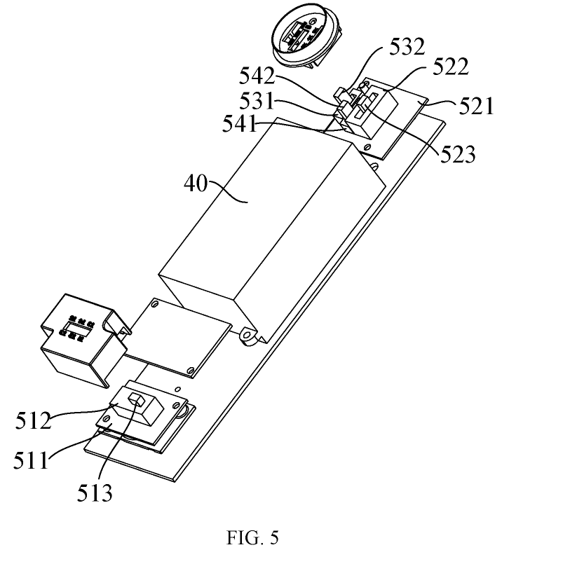

Referring to FIG. 5, the control device 50 includes an angle controller 51 including a first base 511 installed on the seat 10, a first switch 512 arranged on the first base 511, and a first lever 513, wherein the first switch 512 is electrically connected to the power supply 40 and the plurality of groups of LED beads 22, respectively, and has a plurality of states, and the first switch 512 is configured to control at least one group of the plurality of groups of LED beads 22 to emit light by adjusting different states of the plurality of states. In the embodiment of the present disclosure, the first switch 512 includes seven states as below:
when the switch 512 is in a first state, the first beads 221 turn on to emit light; and wherein
when the switch 512 is in a second state, the first and second beads 221, 222 turn on to emit light; and wherein
when the switch 512 is in a third state, the second beads 222 turn on to emit light; and wherein
when the switch 512 is in a fourth state, the plurality of groups of LED beads 22 is simultaneously turned on to emit light; and wherein
when the switch 512 is in a fifth state, the third beads 223 turn on to emit light; and wherein
when the switch 512 is in a sixth state, the third and fourth beads 223, 224 turn on to emit light; and wherein
when the switch 512 is in a seventh state, the fourth beads 224 turn on to emit light.

Specifically, in an embodiment of the present disclosure, the first base 511 is made of flame-retardant plastic material that is injection molded and can be fixed to the seat 10 by screws. The first switch 512 is a multi-position sliding switch, installed in the center of the first base 511, and integrates a plurality of relay contacts inside. Two ends of the first switch 512 are electrically connected to an output terminal of the power supply 40 and control circuits of the plurality of groups of LED beads 22 through wires, which can switch between three or more working states (such as gear 1, gear 2 and gear 3). The first lever 513 is connected to a sliding mechanism of the first switch 512, and a surface of the first lever 513 is designed with anti-slip texture, so that the first lever 513 is easy to be manually operated.

In the embodiment of the present disclosure, seven lighting modes are provided below:
a first mode (Key Lighting): only the first group of yellow beads turn on, which is suitable for museum exhibit lighting;
a second mode (Warm Light Environment): simultaneously turning on the first bead 221 (the yellow bead) and the second bead 222 (the pink bead) to create a warm atmosphere;
a third mode (Romantic Atmosphere): only turning on the second bead 222 (the pink bead), which is suitable for scenes such as restaurants and bars;
a fourth mode (Full Cene Lighting): the four groups of beads are fully turned on to meet needs of a multifunctional space;
a fifth mode (Cold Light Focusing): only turning on the third bead 223 (the cyan bead), which is suitable for lighting in key areas of an office;
a sixth mode (Wide Area Lighting): simultaneously turning on the third bead 223 (the cyan bead) and the fourth bead 224 (the green bead) for large-area lighting in conference rooms and other areas; and
a seventh mode (Environmental Atmosphere): only turning on the fourth bead 224 (the green bead), which can be used as night auxiliary lighting or decorative light.

It should be noted that the angle controller 51 also includes a first box cover configured to cover the angle controller 51 to protect the angle controller 51. There is also a gear indicator arranged on the first box cover. The first lever 513 can extend out of the first box cover to facilitate quick adjustment to the desired gear.

Furthermore, the control device 50 further includes a power controller 52 including a second base 521, a second switch 522, and a second lever 523, wherein the second switch 522 is electrically connected to the power supply 40 and the LED plate 20, respectively, and has a plurality of states, the second lever 523 connected to the second switch 522 and configured to be turned to change the state of the second switch 522, and the second switch 522 configured to control an output power of the LED lamp 100 according to different states thereof.

Specifically, the power controller 52, which is taken as an extension module of the control device 50, consists of the second base 521, the second switch 522 and the second lever 523. The second base 521 can be made of high-strength engineering plastic. The second switch 522 can be equipped with a solid-state relay module, which has multiple-power regulation capabilities. For example, the second switch 522 has the ability to adjust seven levels of power, with each level having a step size of 15% of the rated power. The second lever 523 can be slidably arranged on the second base 521. By manipulating the second lever 523, the present disclosure can adjust the power of the LED lamp 100 by moving the second switch 522 to different states.

Furthermore, the control device 50 further includes a color temperature controller 53 including a third switch 531 and a third lever 532, wherein the third switch 531 is fixedly installed on the second base 521 and electrically connected to the power supply 40 and the LED plate 20, respectively, and has a plurality of states; and wherein the third lever 532 is connected to the third switch 532 and configured to be turned to change the state of the third switch 531, and the third switch 531 is configured to control the color temperature of the LED lamp 100 according to different states thereof.

In an embodiment of the present disclosure, the color temperature controller 53 is linked with the power controller 52 and the angle controller 51, which can jointly control the color temperature, the power, and the angle to adjust the suitable light distribution to meet different needs thereof.

The LED lamp 100 of the present disclosure can have multiple states:
when a beam angle of 7H7V and a color temperature of 3000K are required, the first bead 221 is turned on to emit light;
when a beam angle of 7H7V and a color temperature of 4000K are required, both the first bead 221 and the second bead 222 are turned on to emit light;
when a beam angle of 7H7V and a color temperature of 5000K are required, the second bead 222 is turned on to emit light;
when a beam angle of 7H7V and a color temperature of 3000K are required, all the first bead 221, the second bead 222, the third bead 223 and the fourth bead 224 are turned on to emit light;
when a beam angle of 6H6V and a color temperature of 4000K are required, the first bead 221, the second bead 222, the third bead 223, and the fourth bead 224 are all turned on to emit light;
when a beam angle of 6H6V and a color temperature of 5000K are required, the first bead 221, the second bead 222, the third bead 223, and the fourth bead 224 are all turned on to emit light;
when a beam angle of 5H5V and a color temperature of 3000K are required, the third bead 223 is turned on to emit light. In two adjacent third beads 223, one has a brightness of 70% and the other has a brightness of 30%;
when a beam angle of 5H5V and a color temperature of 4000K are required, both the third bead 223 and the fourth bead 224 are turned on to emit light; and
when a beam angle of 5H5V and a color temperature of 5000K are required, the fourth bead 224 is turned on to emit light. In two adjacent fourth beads 224, one has a brightness of 70% and the other has a brightness of 30%.

Furthermore, the control device 50 further includes a main switch 54 configured to control the LED lamp 100 to be turned on or turned off. The main switch 54 includes a fourth switch 541 and a fourth lever 542. The fourth switch 541 is mounted on the second base 521 and is electrically connected to the power supply 40 and the LED beads 22, respectively. The fourth switch 541 has different states and is configured to control whether the LED lamp 100 is turned on or turned off according to different states.

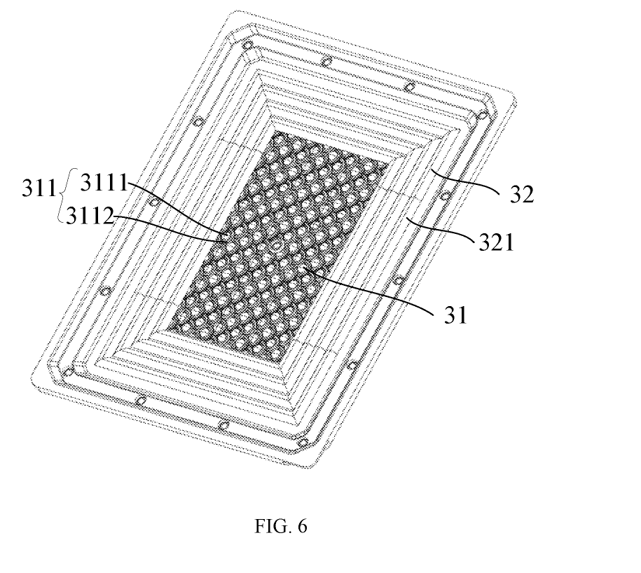

Referring to FIG. 6, the lens 30 includes a central lens module 31 and a peripheral lens module 32 connected with each other, wherein the peripheral lens module 32 is corresponding to the third beads 223 and the fourth beads 224, and the central lens module 31 is corresponding to the first beads 221 and the second beads 222. The central lens module 31 includes a plurality of central lens units 311 arranged in one-to-one correspondence with the first beads 221 and the second beads 222. The peripheral lens module 32 includes a plurality of rectangular convex lens units 321 arranged in sequence, each of the plurality of rectangular convex lens units 321 corresponding to a rectangular ring that is formed by enclosing the third bead 223 and the fourth bead 224.

Specifically, in an embodiment of the present disclosure, the lens 30 adopts a layered modular design. The central lens module 31 is composed of N independent central lens units 311 (N is the total number of LED beads 22 that contain the first beads 222 and the second beads 223), and each central lens unit 311 corresponds to one first bead 221 or one second bead 222. The peripheral lens module 32 includes M rectangular convex lens units 321 (M is the number of rings formed by the third beads 223 and the fourth beads 224), which are arranged from the first ring to the M-th ring from the inside to the outside of the center of the substrate 21, with each ring corresponding to a group of circularly arranged third beads 223 or fourth beads 224. each of the plurality of central lens units 31 includes a hemispherical convex portion 3111 and a convex ring portion 3112 wound around the outside of the hemispherical convex portion 3111, wherein the hemispherical convex portion 3111 protrudes from the convex ring portion 3112.

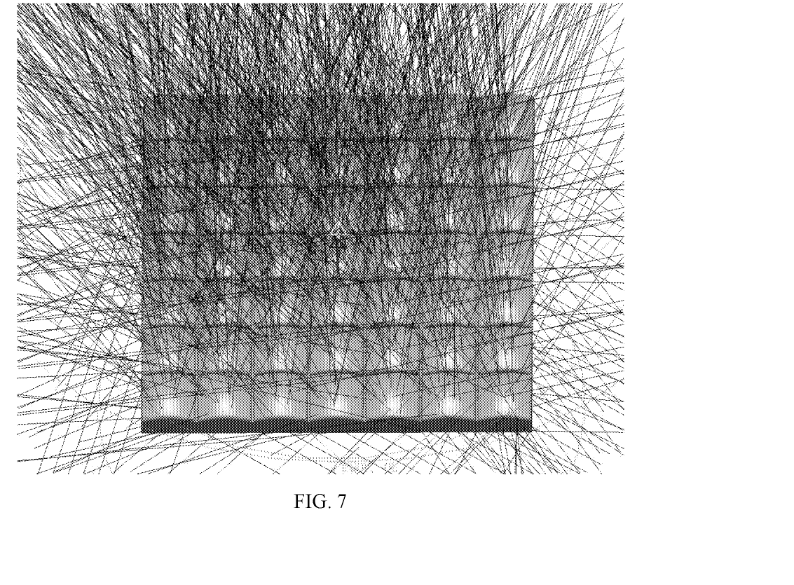

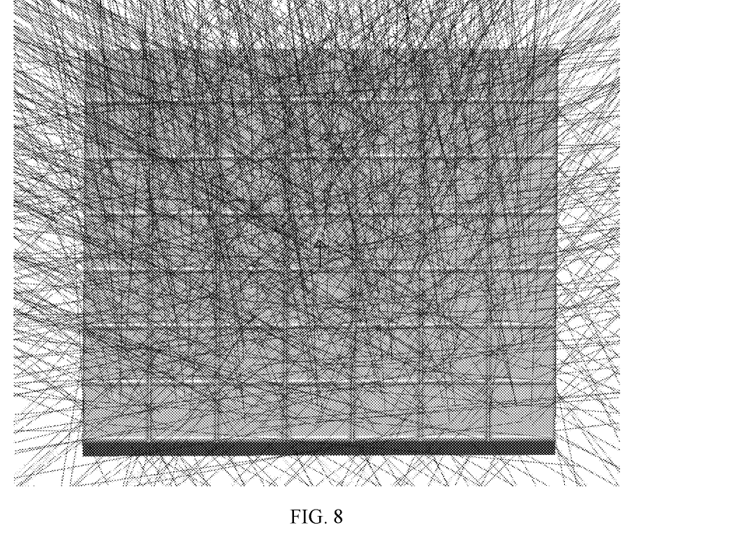

Referring to FIGS. 7 and 8, FIG. 7 is a schematic view of light emission after simulating an emission angle of a central lens module of the LED lamp through an optical software. In FIG. 7, there are the plurality of hemispherical convex portions 3111. Light is emitted from below the central lens module 31, and it can be seen that most of the light is concentrated in an upper half of the image, thereby presenting a first emission angle thereof. Compared to FIG. 8, FIG. 8 is a schematic view of light emission after simulating an emission angle of a peripheral lens module of the LED lamp through the optical software. The peripheral lens module 32 includes the plurality of stepped-rectangular convex lens units 321. FIG. 8 simulates the plurality of rectangular convex lens units 321. It can be seen from FIG. 8 that the concentration of light passing through the rectangular convex lens units 321 is significantly lower than that of FIG. 7. Moreover, it is seen from the emission angle, a range of the emission angle is greater, which clearly corresponds to a second emission angle that is greater than the first emission angle.

When the lens 30 (including the central lens module 31 and the peripheral lens module 32) with a layered modular design is combined and manufactured, two different lighting angles can be adjusted by controlling the lighting of the first bead 221 and the second bead 222, or by controlling the lighting of the third bead 223 and the fourth bead 224.

Furthermore, the LED lamp 100 further includes a transparent cover 60 installed on the seat 10 and located on the outer of the lens 30. In an embodiment of the present disclosure, the transparent cover 60 can be made of tempered glass, and an inner surface of the tempered glass can be coated with an anti-reflective film to reduce reflection glare thereof. A sealing rubber ring is installed between the transparent cover 60 and the seat 10 to form an IP65 dustproof and waterproof rating thereof.

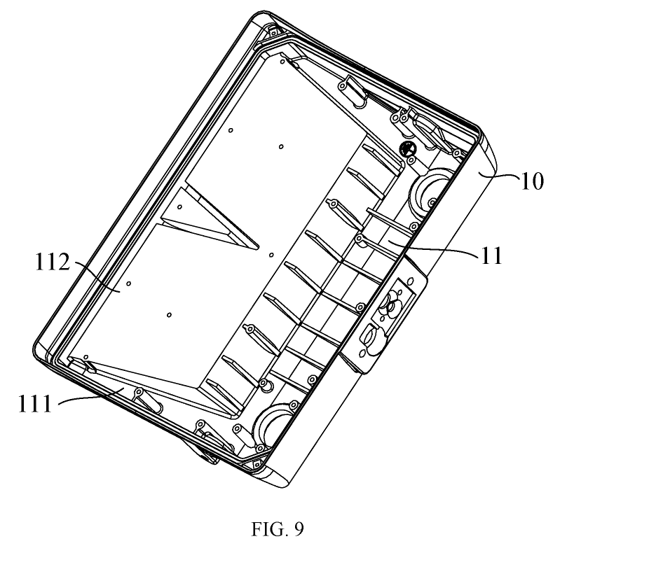

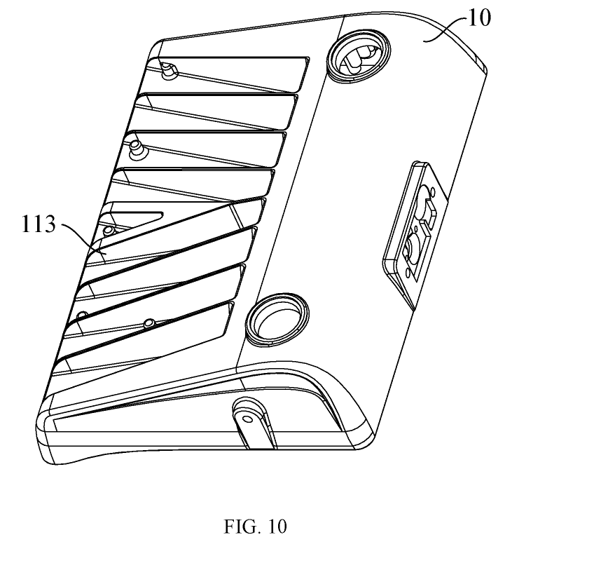

Referring to FIGS. 9 and 10, a bottom wall 111 of the installation groove 11 protrudes towards a side of the LED plate 20 to form a bulge 112, and the LED plate 20 is installed on the bulge 112. A thermal conductive silicone is installed between the LED plate 20 and the bulge 112 to conduct heat emitted by the LED plate 20 to the seat 10, and then guide the heat to the outside through the seat 10. A plurality of heat dissipation fins 113 is installed on the back of the bottom wall 111 to increase a surface area of the seat 10 and enhance the heat dissipation effect thereof.

In an embodiment of the present disclosure, the LED lamp 100 further includes an installation bracket 70 installed on the seat 10, wherein the installation bracket 70 includes a first bracket 71 and a second bracket 72 connected to each other, the second bracket 72 configured to connect the LED lamp 100 to an outer position. The first bracket 71 and the second bracket 72 are rotatably connected to each other to adjust an orientation of the seat 10, thereby adjusting the light emission direction of the LED beads 22.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

What is claimed is:

1. An LED lamp comprising:
a seat with an installation groove thereof;
an LED plate received in the installation groove;
a lens covered outside the LED plate;
a power supply electrically connected to the LED plate;
a control device electrically connected to the power supply and configured to control the LED plate to emit light; and wherein
the LED plate comprises a substrate and a plurality of groups of LED beads arranged in different areas of the substrate in a mutually spaced manner; and wherein color temperatures and light emission angles of at least two groups of the plurality of groups of LED beads are different, and the control device is configured to independently control at least one group of the plurality of groups of LED beads to emit light.

2. The LED lamp as claimed in claim 1, wherein the substrate is square, and the plurality of groups of LED beads is arranged in an array along directions parallel to long sides and short sides of the substrate, respectively.

3. The LED lamp as claimed in claim 2, wherein the plurality of groups of LED beads comprises a first bead, a second bead, a third bead and a fourth bead, wherein the first bead and the second bead are distributed in an array at a middle position of the substrate, and the third bead and the fourth bead are respectively surrounded around the periphery of the first bead and the second bead.

4. The LED lamp as claimed in claim 3, wherein the first bead and the second bead form a plurality of rows that is arranged in sequence along a width direction of the substrate, each row of first beads or the second beads are evenly distributed along a length direction of the substrate, wherein the first beads is arranged on odd rows, while the second beads are arranged on even rows, and the second beads in each even row are offset relative to the first beads in adjacent odd rows along the length direction of the substrate.

5. The LED lamp as claimed in claim 4, wherein the first beads and the second beads also form a plurality of columns, wherein odd columns are composed of the first beads and even columns are composed of the second beads; and wherein a plurality of isosceles right-angled triangles is formed between the first beads and the second beads, two right-angled sides of each of the plurality of isosceles right-angled triangles extending along the length and width directions of the substrate, respectively, a vertex of the right-angled triangle is either the first bead or the second bead, two ends of the hypotenuse are either two first beads or two second beads, and the two first beads and the two second beads in the hypotenuse are alternately arranged.

6. The LED lamp as claimed in claim 4, wherein the plurality of rows of third and fourth beads is arranged in a plurality of concentric rectangular rings along the peripheral area of the substrate, wherein at least one rectangular ring of the plurality of concentric rectangular rings is composed of the third beads, at least another rectangular ring is composed of the fourth beads, and the plurality of rectangular rings are alternately arranged by the third beads and the fourth beads, and adjacent rectangular rings are nested with each other; and wherein a distance between two adjacent third beads is equal to a distance between two adjacent fourth beads, and in two adjacent rectangular rings, the third beads and the fourth beads are arranged opposite each other in a direction perpendicular to an edge of the ring.

7. The LED lamp as claimed in claim 3, wherein a color temperature of the first bead is 5000K and emission angles are 5H5V and 6H6V, a color temperature of the second bead is 3000K and emission angles are 5H5V and 6H6V, a color temperature of the third bead is 5000K and an emission angle is 7H7V, and a color temperature of the fourth LED bead is 3000K and an emission angle is 7H7V.

8. The LED lamp as claimed in claim 7, wherein the control device comprises an angle controller comprising a first base installed on the seat, a first switch arranged on the first base, and a first lever, wherein the first switch is electrically connected to the power supply and the plurality of groups of LED beads, respectively, and has a plurality of states, and the first switch is configured to control at least one group of the plurality of groups of LED beads to emit light by adjusting different states of the plurality of states.

9. The LED lamp as claimed in claim 8, wherein the plurality of states of the first switch comprises seven states:
when the switch is in a first state, the first beads turn on to emit light; and wherein
when the switch is in a second state, the first and second beads turn on to emit light; and wherein
when the switch is in a third state, the second beads turn on to emit light; and wherein
when the switch is in a fourth state, the plurality of groups of LED beads is simultaneously turned on to emit light; and wherein
when the switch is in a fifth state, the third beads turn on to emit light; and wherein
when the switch is in a sixth state, the third and fourth beads turn on to emit light; and wherein
when the switch is in a seventh state, the fourth beads turn on to emit light.

10. The LED lamp as claimed in claim 3, wherein the lens comprises a central lens module and a peripheral lens module connected with each other, wherein the peripheral lens module is corresponding to the third beads and the fourth beads, and the central lens module is corresponding to the first beads and the second beads.

11. The LED lamp as claimed in claim 10, wherein the central lens module comprises a plurality of central lens units arranged in one-to-one correspondence with the first beads and the second beads.

12. The LED lamp as claimed in claim 11, wherein each of the plurality of central lens units comprises a hemispherical convex portion and a convex ring portion wound around the outside of the hemispherical convex portion, wherein the hemispherical convex portion protrudes from the convex ring portion.

13. The LED lamp as claimed in claim 10, wherein the peripheral lens module comprises a plurality of rectangular convex lens units arranged in sequence, each of the plurality of rectangular convex lens units corresponding to a rectangular ring that is formed by enclosing the third bead and the fourth bead.

14. The LED lamp as claimed in claim 10, wherein the control device further comprises a power controller comprising a second base, a second switch, and a second lever, wherein the second switch is electrically connected to the power supply and the LED plate, respectively, and has a plurality of states, the second lever connected to the second switch and configured to be turned to change the state of the second switch, and the second switch configured to control an output power of the LED lamp according to different states thereof.

15. The LED lamp as claimed in claim 14, wherein the control device further comprises a color temperature controller comprising a third switch and a third lever, wherein the third switch is fixedly installed on the second base and electrically connected to the power supply and the LED plate, respectively, and has a plurality of states; and wherein the third lever is connected to the third switch and configured to be turned to change the state of the third switch, and the third switch is configured to control the color temperature of the LED lamp according to different states thereof.

16. The LED lamp as claimed in claim 15, wherein the control device further comprises a main switch configured to control the LED lamp to be turned on or turned off.

17. The LED lamp as claimed in claim 10, wherein the LED lamp further comprises a transparent cover installed on the seat and located on the outer of the lens.

18. An LED lamp comprising:
a seat with an installation groove thereof;
an LED plate received in the installation groove;
a lens covered outside the LED plate;
a power supply electrically connected to the LED plate;
a control device electrically connected to the power supply and configured to control the LED plate to emit light; and wherein
the LED plate comprises a substrate and first beads, second beads, third beads and fourth beads attached to the substrate, respectively, wherein the first beads and the second beads are located at a middle position of the substrate, and the third beads and the fourth beads are surrounded around the periphery of the first beads and the second beads; and wherein the control device is configured to control at least one of the first beads, the second beads, the third beads and the fourth beads to emit light, so as to adjust light emission distribution of the LED lamp.

19. The LED lamp as claimed in claim 18, wherein the first beads, the second beads, the third beads and the fourth beads are respectively yellow beads, pink beads, blue beads and green beads, wherein the first beads and the second beads form a plurality of rows that is arranged in sequence along a width direction of the substrate, each row of first beads or the second beads are evenly distributed along a length direction of the substrate, wherein the first beads is arranged on odd rows, while the second beads are arranged on even rows, and the first beads and the second beads in adjacent rows are staggered along the length direction of the substrate; and wherein the third beads and the fourth beads are arranged in a plurality of concentric rectangular rings along the peripheral area of the substrate, wherein at least one rectangular ring of the plurality of concentric rectangular rings is composed of the third beads, at least another rectangular ring is composed of the fourth beads, and the plurality of rectangular rings are alternately arranged by the third beads and the fourth beads, and adjacent rectangular rings are nested with each other; and wherein a distance between two adjacent third beads is equal to a distance between two adjacent fourth beads, and in two adjacent rectangular rings, the third beads and the fourth beads are arranged opposite each other in a direction perpendicular to an edge of the ring.

20. The LED lamp as claimed in claim 17, wherein a bottom wall of the installation groove protrudes towards a side of the LED plate to form a bulge, and the LED plate is installed on the bulge, wherein the LED lamp further comprises an installation bracket installed on the seat, wherein the installation bracket comprises a first bracket and a second bracket connected to each other, the second bracket configured to connect the LED lamp to the outside, and the first bracket and the second bracket rotatably connected to each other.
